(19) United States
(12) Patent Application Publication
(10) Pub. No.: US 2007/0159631 A1
(43) Pub. Date: Jul. 12, 2007

(54) TRANSPARENT WAFER WITH OPTICAL ALIGNMENT FUNCTION AND FABRICATING METHOD AND ALIGNMENT METHOD THEREOF

(76) Inventors: Yu-Lin Huang, Taipei County (TW); Dun-Ying Shu, Hsinchu County (TW); Kuo-Ting Wu, Taipei City (TW); Jun-Yao Huang, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,615

(22) Filed: Apr. 12, 2006

(30) Foreign Application Priority Data
Jan. 11, 2006 (TW) 95101032

(51) Int. Cl. G01B 11/00

(52) U.S. Cl. 356/400

(57) ABSTRACT

A transparent wafer with optical alignment function is provided. The transparent wafer includes a transparent substrate with an alignment feature on the edge and an opaque layer at least disposed along the peripheral area on the surface of the transparent substrate. The opaque layer can absorb or reflect the detecting light, thus the transparent wafer can be aligned by detecting the alignment feature. The present invention also includes the fabricating method and alignment method of the transparent wafer with optical alignment function.

### CROSS-REFERENCE TO RELATED APPLICATION

This application claims the priority benefit of Taiwan application serial no. 95101032, filed on Jan. 11, 2006. All disclosure of the Taiwan application is incorporated herein by reference.

### BACKGROUND OF THE INVENTION

1. Field of Invention

The present invention relates to a semiconductor structure. More particularly, the present invention relates to a transparent wafer, fabricating method and alignment method thereof.

2. Description of Related Art

As the development of the semiconductor industry, many film layers are usually formed on a silicon wafer, and the wafer is completed after many fabricating processes. Therefore, in order to align each film layer accurately, an aligning process is usually performed before starting the fabricating process.

Referring to FIG. 1, FIG. 1 is a schematic diagram of the conventional semiconductor device. The silicon wafer 100 disposed in the semiconductor device 102 is an opaque wafer, and the silicon wafer 100 has an alignment cut 105, usually a V-shaped notch (as shown in FIG. 1) or a flat portion. The light source 110 emits a detecting light 115, and an optical detecting device 120 receives the detecting light 115. When the detecting light 115 is obstructed, it means that a silicon wafer 100 is coming in, and the semiconductor device 102 will perform the pre-determined operation automatically. In addition, the light source 110 is disposed at the edge of the silicon wafer 100. When the detecting light 115 passes through the alignment cut 105, the alignment function is actuated, and the semiconductor device 102 performs the subsequent fabricating processes.

However, when using the transparent wafer, the aforementioned device can not perform the detecting and aligning actions. Therefore, U.S. Pat. No. 6,229,611 provides a detecting method for the transparent wafer. Referring to FIG. 2, FIG. 2 is a schematic diagram of the method of detecting the quartz wafer in a semiconductor device. According to the method, an opaque material of poly-silicon layer 210 is coated on the whole back surface of the quartz wafer 200. Thus, the quartz wafer 200 turns to an opaque wafer, so that it can operate in the conventional conductor device.

However, the method still has many problems: (1) coating a poly-silicon layer 210 on the whole back surface of the quartz wafer 200 needs much opaque material; (2) in order to keep the cleanness of the front surface for convenience to fabricate devices, the poly-silicon layer 210 can only be coated on the back surface of the quartz wafer 200; (3) after being in contact with mechanical devices, the big-area poly-silicon layer 210 disposed on the back surface of the quartz wafer 200 may shed off gradually, and accumulate and turn into contamination source, which may fatally damage the cleanness condition required in the fabricating process of semiconductor, and further contaminate the wafer product.

### SUMMARY OF THE INVENTION

Accordingly, the present invention is directed to provide a transparent wafer with optical alignment function, which can be easily detected and aligned using the existing optical detecting device, and will not affect the area for fabricating devices in the center of the transparent wafer.

Another aspect of the present invention is to provide a fabricating method of the transparent wafer with optical alignment function, and the method includes: forming an opaque layer at the peripheral area of the transparent wafer. The method is not only simple, but also uses less opaque material; and further, the fabricating cost can be saved.

Another aspect of the present invention is to provide an alignment method of the transparent wafer with optical alignment function, which can apply existing optical detecting device to detect the alignment feature on the edge of the transparent wafer so as to achieve the alignment effect.

The present invention provides a transparent wafer with optical alignment function, and the transparent wafer comprises a transparent substrate, and an opaque layer is at least disposed along the peripheral area on the surface of the transparent substrate. The edge of the transparent substrate has an alignment feature. The opaque layer can absorb or reflect the detecting light, thus, the transparent wafer can be aligned by detecting the alignment feature.

According to the above transparent wafer with optical alignment function, the opaque layer is disposed on at least one of the front surface or the back surface of the transparent substrate. The material of the opaque layer is, for example, selected from the group comprising resin ink and glyceride ink.

According to the above transparent wafer with optical alignment function, the opaque layer can be an opaque adiabatic paper or the compound structure of transparent electrode/liquid crystal/transparent electrode. The opaque layer can also comprise at least two polarizers with different polarizing axes.

According to the above transparent wafer with optical alignment function, the material of the transparent substrate includes one of quartz, glass and transparent plastic.

The above transparent wafer with optical alignment function of the present invention can be applied to the current conventional optical detecting device to detect the transparent wafer; moreover, the area for fabricating devices in the center of the transparent wafer will not be affected because the opaque layer is disposed at the peripheral area of the transparent wafer, so that the output of devices per wafer still can be maintained.

The present invention provides a fabricating method of the transparent wafer with optical alignment function. The method includes: first, a transparent substrate with an alignment feature on the edge is provided; then, an opaque layer is formed at least along the peripheral area on the surface of the transparent substrate, and the opaque layer can absorb or reflect the detecting light.

The fabricating method of the transparent wafer with optical alignment function further includes forming an opaque layer at the peripheral area on at least one of the front surface or back surface of the transparent substrate.

According to the above fabricating method of the transparent wafer with optical alignment function, the material of the opaque layer includes the group comprising resin ink and glyceride ink.

According to the above fabricating method of the transparent wafer with optical alignment function, the opaque layer may be an opaque adiabatic paper. In addition, the opaque layer may be the compound structure of transparent electrode/liquid crystal/transparent electrode. Moreover, the opaque layer can also comprise at least two polarizers with different polarizing axes.

According to the above fabricating method of the transparent wafer with optical alignment function, the material of the transparent substrate includes one of quartz, glass and transparent plastic.

According to the fabricating method, as the opaque layer is formed along the peripheral area of the transparent substrate, not on the whole back surface, so that the usage of the opaque material is substantially reduced and the fabricating cost is saved.

The present invention provides an alignment method of the transparent wafer with optical alignment function. The method includes, for example, first, a transparent substrate with an alignment feature on the edge is provided, wherein the transparent wafer comprises a transparent substrate and an opaque layer is disposed at least along the peripheral area on the surface of the transparent substrate; then, providing an optical detecting device for detecting the transparent wafer, and the detecting light emitted from the optical detecting device may be absorbed or reflected by the opaque layer; next, moving the transparent wafer until the optical detecting device detects the alignment feature of the transparent wafer.

According to the alignment method of the transparent wafer with optical alignment function, the opaque layer can be disposed on one of the front surface or back surface of the transparent substrate.

According to the alignment method of the transparent wafer with optical alignment function, the material of the opaque layer includes the group comprising resin ink and glyceride ink. In addition, the opaque layer may be an opaque adiabatic paper.

According to the alignment method of the transparent wafer with optical alignment function, the opaque layer is the compound structure of transparent electrode/liquid crystal/transparent electrode. The method further includes providing an extra voltage to control the opaque layer whether to have the detecting light pass or not.

According to the alignment method of the transparent wafer with optical alignment function, the opaque layer comprises at least two polarizers with different polarizing axes.

According to the alignment method of the transparent wafer with optical alignment function, the material of the transparent substrate includes one of quartz, glass and transparent plastic.

As the present invention applies the transparent wafer with opaque layer, when aligning the transparent wafer, the present invention can use the existing optical detecting device to detect the alignment feature disposed at the edge of the transparent wafer, so as to achieve the alignment effect. Therefore, no additional detecting or aligning device is needed for the transparent wafer.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional semiconductor device.

FIG. 2 is a schematic diagram of a conventional method of detecting the quartz wafer in the semiconductor device.

FIG. 3 is a top view of a transparent wafer with optical alignment function according to one embodiment of the present invention.

FIG. 4 is a schematic cross-sectional diagram along I-I′ in FIG. 3.

FIG. 5 is a schematic diagram of a semiconductor device used in the alignment method of the transparent wafer according to one embodiment of the present invention.

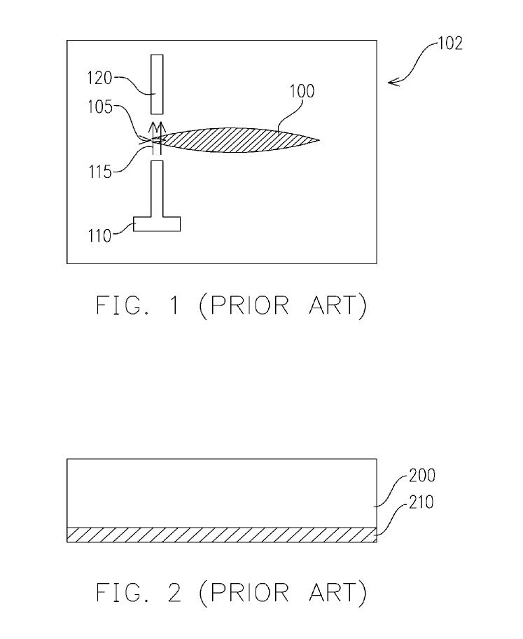

### DESCRIPTION OF EMBODIMENTS

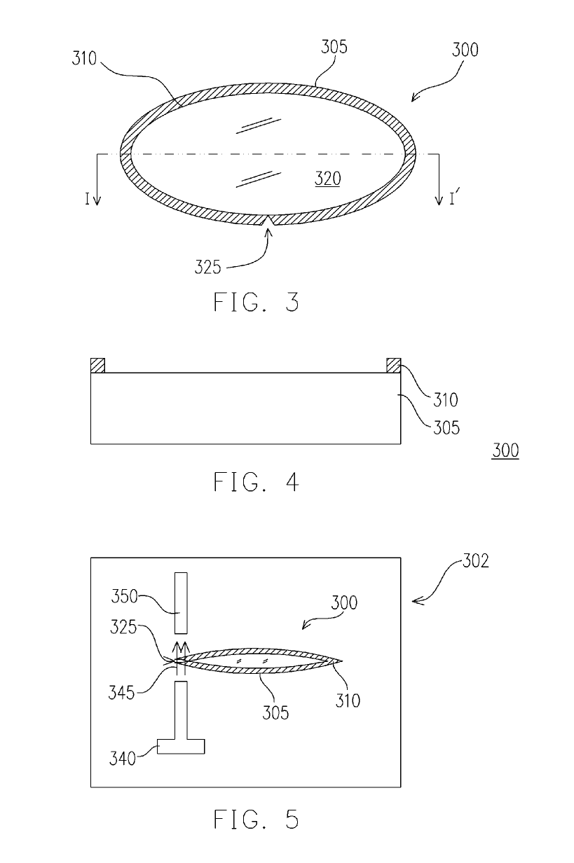

FIG. 3 is a top view of a transparent wafer with optical alignment function according to one embodiment of the present invention. Referring to FIG. 3, the transparent wafer 300 includes a transparent substrate 305 with an alignment feature 325 on the edge and an opaque layer 310 at least disposed along the peripheral area on the surface of the transparent substrate 300. The opaque layer 310 can absorb or reflect the detecting light, so that the transparent wafer 300 can be aligned by the alignment feature 325.

Wherein, the material of the transparent substrate 305 is one of quartz, glass or transparent plastic. The central transparent area 320 of the transparent wafer 300, where no opaque layer 310 is disposed, still has the transparency feature. The alignment feature 325 is, for example, a V-shaped notch (as shown in FIG. 3), other shaped notch or a flat portion.

The opaque layer 310 is, for example, disposed on one of the front surface and back surface of the transparent substrate 305 or the opaque layer 310 is disposed on both surfaces. The width of the opaque layer 310 is approximately equal to the width of the alignment feature 325 as along as the detecting light can detect the alignment feature 325 at the edge of the wafer 300. Taking the 8 inch transparent substrate 305 as an example, the width of the opaque layer 310 is about 8 mm. Of course, the opaque layer 310 also can be disposed on the entire back surface of the transparent substrate 305, not limited to be disposed on the peripheral area of the transparent substrate 305.

The material of the opaque layer 310 is, for example, selected form the group comprising resin ink and glyceride ink, or is an opaque adiabatic paper. The opaque layer 310 may also be the compound structure of transparent electrode/liquid crystal/transparent electrode, wherein the material of the transparent electrode is, for example, indium tin oxide (ITO) or indium zinc oxide (IZO), etc. Moreover, the opaque layer 310 also may comprise two polarizers with different polarizing axes directions, for example, two polarizers with two perpendicular polarizing axes; accordingly, all the light beams can be filtered.

According to the transparent wafer 300 with optical alignment function, an opaque layer 310, which can absorb and detect the detecting light, is disposed along the peripheral area on the surface of the transparent substrate. Utilizing the opaque layer 310 and the alignment feature 325 disposed on the edge of the transparent substrate 305, the detecting light can be used to align the transparent wafer by the current conventional optical device detecting and the alignment feature 325 (i.e., when the detecting light passes through the notch). Thus, no additional detecting & aligning device is needed for the transparent wafer, so that the device cost can be reduced.

Moreover, as the opaque layer 310 is only disposed on the peripheral area of the transparent substrate 305, which will not affect the effective area in the center of the transparent wafer 300 for fabricating devices, so that the output of devices per wafer can still be maintained.

Next, the fabricating method of the transparent wafer with optical alignment function is described. FIG. 4 is a cross-sectional diagram along I-I′ in FIG. 3.

Referring to FIG. 3 and FIG. 4, the present invention provides a fabricating method of the transparent wafer with optical alignment function. The method includes: first, a transparent substrate 305 with an alignment feature 325 on the edge is provided. The material of the transparent substrate 305 is one of quartz, glass or transparent plastic. The alignment feature 325 is a V-shaped notch (as shown in FIG. 3), or other shaped notches, or a flat portion.

Then, an opaque layer 310 is formed at least along the peripheral area of the transparent substrate 305, and the opaque layer 310 can absorb or reflect the detecting light. The opaque layer 310 is, for example, disposed on the front surface (as shown in FIG. 4), or on the back surface of the transparent substrate 305.

The material of the opaque layer 310 is selected form the group comprising resin ink and glyceride ink, and the formation method includes, for example, coating on the peripheral area of the front surface of the transparent substrate 305 using the EBR nozzle of the photoresist developer after the photoresist is coated. The opaque layer 310 of the material can be removed using organic solvent by the aforementioned EBR nozzle so that it will not shed off; accordingly, the possibility of fabricating process contamination can be reduced.

The opaque layer 310 may also be the compound structure of transparent electrode/liquid crystal/transparent electrode, wherein the material of the transparent electrode is, for example, metal oxide, such as ITO, IZO, etc. The opaque layer 310 is made by posting a compound structure of transparent electrode/liquid crystal/transparent electrode at the edge of the front surface of the transparent substrate 305 before coating the photoresist. The external voltage coupled to the compound structure can determine the arrangement change of the liquid crystal molecules, and further control whether to have the detecting light pass through.

Moreover, the opaque layer 310 may also comprise at least two polarizers with different polarizing axes. For example, the polarizers with two perpendicular polarizing axes are respectively attached on the front surface and the back surface of the transparent substrate 305 so as to obstruct the pass of the detecting light. Of course, both of the two polarizing boards can be attached on the front surface or the back surface of the transparent substrate 305 according to the design of the fabricating process.

Moreover, the opaque layer 310 may also be an opaque adiabatic paper. For example, before the photoresist is coated, the opaque adiabatic paper is attached on the peripheral area of the back surface or the whole back surface of the transparent substrate 305. The opaque adiabatic paper is, for example, torn off before the successive high temperature fabricating process.

According to the fabricating method of the transparent wafer with optical alignment function, as the opaque layer 310 is formed at the peripheral area on the surface of the transparent substrate 305, but not formed on the whole back surface, the consumption of the opaque material is substantially reduced so that the cost is saved. Moreover, as the opaque layer 310 is just formed on the peripheral area of the surface of the transparent substrate 305, and the material is easy to be removed, the possibility of the opaque layer shedding to cause contamination can be substantially reduced, and further the cleanness of the fabricating process can be improved.

The following will describe the alignment method of the opaque wafer with optical alignment function. FIG. 5 is a schematic diagram of a semiconductor device used in the alignment method of the transparent wafer according to one embodiment of the present invention.

Referring to FIG. 3 and FIG. 5, the method includes, for example, first, a transparent wafer 300 is provided, wherein the transparent wafer 300 comprises the transparent substrate 305, and the opaque layer 310 disposed at least along the peripheral area on the surface of the transparent substrate 300. The transparent substrate 305 has the alignment feature 325 at the edge, and the alignment feature 325 is, for example, V-shaped notch (as shown in FIG. 3) or other types of notch, or a flat portion. The materials of the transparent substrate 305 and the opaque layer 310 have been described above, so that the detail is omitted here. It needs to be noticed that when the opaque layer 310 applies the compound structure of transparent electrode/liquid crystal/transparent electrode, an external voltage is coupled to the compound structure so as to determine the alignment change of the liquid crystal molecules and further to control whether to allow the successive detecting light to pass through or not.

Then, an optical detecting device is provided, which is used for detecting the transparent wafer 300. The optical detecting device comprises, for example, a light source 340 and an optical detecting device 350 (as shown in FIG. 5). Of course, the light source 340 in FIG. 5 and the optical detecting device 350 are disposed on the two opposite sides of the transparent wafer 310, respectively and the optical detecting device also can be disposed in other manner.

As the detecting light 345 emitted from the light source 340 may be absorbed or reflected by the opaque layer 310 so as to obstruct the detecting light to pass through. The alignment feature 325 allows the detecting light 345 to pass through, and the optical detecting device 350 receives the detecting light 345. Therefore, the transparent wafer 300 is then moved until the optical detecting device can detect the alignment feature 325 on the edge of the transparent substrate 305 so as to trigger the semiconductor device 302 to perform alignment and the successive fabricating processes.

As the present invention applies the transparent wafer with optical alignment function and the opaque layer is at least disposed along the peripheral area of the transparent substrate, when aligning the transparent wafer, the existing optical detecting device can be utilized to detect the alignment feature on the edge of the transparent wafer so as to achieve the alignment effect. Therefore, not only no additional delicate detecting or aligning device is needed for the transparent wafer, but also the opaque material consumption can be saved, and the possibility of optical layer shedding resulting in fabricating process contamination can also be reduced. Therefore, the fabricating cost is reduced and the cleanness of the fabricating process is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transparent wafer with optical alignment function, comprising:
a transparent substrate, having an alignment feature on the edge; and
an opaque layer, at least disposed along the peripheral area on the surface of the transparent substrate, and the opaque layer absorbs or reflects the detecting light; the transparent wafer is aligned by detecting the alignment feature.

2. The transparent wafer with optical alignment function as claimed in claim 1, wherein the opaque layer is disposed on at least one of the front surface or the back surface of the transparent substrate.

3. The transparent wafer with optical alignment function as claimed in claim 1, wherein the material of the opaque layer is selected from the group comprising resin ink and glyceride ink.

4. The transparent wafer with optical alignment function as claimed in claim 1, wherein the opaque layer is an opaque adiabatic paper.

5. The transparent wafer with optical alignment function as claimed in claim 1, wherein the opaque layer is a compound structure of transparent electrode/liquid crystal/transparent electrode.

6. The transparent wafer with optical alignment function as claimed in claim 1, wherein the opaque layer comprises at least two polarizers with different polarizing axes.

7. The transparent wafer with optical alignment function as claimed in claim 1, wherein the material of the transparent substrate includes one of quartz, glass and transparent plastic.

8. A fabricating method of a transparent wafer with optical alignment function, comprising:
providing a transparent substrate with an alignment feature on the edge; and
forming an opaque layer at least along the peripheral area on the surface of the transparent substrate, and the opaque layer absorbs or reflects detecting light.

9. The fabricating method of the transparent wafer with optical alignment function as claimed in claim 8 further comprises forming the opaque layer on the peripheral area of at least one of the front surface or back surface of the transparent substrate.

10. The fabricating method of the transparent wafer with optical alignment function as claimed in claim 8, wherein the material of the opaque layer comprises the group comprising resin ink and glyceride ink.

11. The fabricating method of the transparent wafer with optical alignment function as claimed in claim 8, wherein the opaque layer is an opaque adiabatic paper.

12. The fabricating method of the transparent wafer with optical alignment function as claimed in claim 8, wherein the opaque structure is a compound structure of transparent electrode/liquid crystal/transparent electrode.

13. The fabricating method of the transparent wafer with optical alignment function as claimed in claim 8, wherein the opaque layer comprises at least two polarizers with different polarizing axes.

14. The fabricating method of the transparent wafer with optical alignment function as claimed in claim 8, wherein the material of the transparent substrate comprises one of quartz, glass and transparent plastic.

15. An alignment method of the transparent wafer with optical alignment function, comprising:
providing a transparent substrate, wherein the transparent wafer comprises:
a transparent substrate, having an alignment feature on the edge of the transparent substrate; and
an opaque layer, disposed at least along the peripheral area on the surface of the transparent substrate;
providing an optical detecting device for detecting the transparent wafer, and one detecting light emitted from the optical detecting device is absorbed or reflected by the opaque layer; and
moving the transparent wafer until the optical detecting device detects the alignment feature of the transparent wafer.

16. The alignment method of the transparent wafer with optical alignment function as claimed in claim 15, wherein the opaque layer is disposed on one of the front surface or back surface of the transparent substrate.

17. The alignment method of the transparent wafer with optical alignment function as claimed in claim 15, wherein the material of the opaque layer comprises the group comprising resin ink and glyceride ink.

18. The alignment method of the transparent wafer with optical alignment function as claimed in claim 15, wherein the opaque layer is an opaque adiabatic paper.

19. The alignment method of the transparent wafer with optical alignment function as claimed in claim 15, wherein the opaque layer is a compound structure of transparent electrode/liquid crystal/transparent electrode.

20. The alignment method of the transparent wafer with optical alignment function as claimed in claim 19 further comprises providing an extra voltage to control the opaque layer whether to pass through the detecting light or not.

21. The alignment method of the transparent wafer with optical alignment function as claimed in claim 15, wherein the opaque layer comprises at least two polarizers with different polarizing axes.

22. The alignment method of the transparent wafer with optical alignment function as claimed in claim 15, wherein the material of the transparent substrate includes one of quartz, glass and transparent plastic.
